(19) United States
(12) Patent Application Publication
(10) Pub. No.: US 2026/0046927 A1
(43) Pub. Date: Feb. 12, 2026

(54) PERFORMING A CANDIDATE RESOURCE SELECTION PROCEDURE

(71) Applicant: Lenovo (Singapore) Pte. Ltd., Singapore (SG)

(72) Inventor: Karthikeyan Ganesan, Nauheim (DE)

(21) Appl. No.: 19/102,228

(22) PCT Filed: Aug. 10, 2023
(86) PCT No.: PCT/IB2023/058113

§ 371 Date: Feb. 7, 2025

Related U.S. Application Data
(60) Provisional application No. 63/371,020, filed on Aug. 10, 2022.

(51) Int. Cl. H04W 74/0808; H04W 72/0446; H04W 72/56

(52) U.S. Cl. CPC H04W 74/0808; H04W 72/0446; H04W 72/56

(57) ABSTRACT

Apparatuses, methods, and systems are disclosed for performing a candidate resource selection procedure. One method includes receiving, at a user equipment (“UE”), configuration information including a candidate resource selection procedure to overbook at least one time-frequency resource reserved by at least one second UE and a plurality of listen-before-talk (“LBT”) starting positions for performing LBT. The configuration information includes an overbooking enabled flag, an overbooking factor, a relative priority, a threshold, or some combination thereof. The method includes performing candidate resource selection. The candidate resource selection selects the at least one reserved time-frequency resource that fulfils the overbooking factor, the relative priority, the threshold, or some combination thereof. The method includes reporting the at least one reserved time-frequency resource to a higher layer. The method includes determining an LBT starting position from the plurality of LBT starting positions.

### FIELD

The subject matter disclosed herein relates generally to wireless communications and more particularly relates to performing a candidate resource selection procedure.

### BACKGROUND

In certain wireless communications systems, sidelink (“SL”) resources may become overbooked. In such systems, the overbooked SL resources may result in wasted resources.

### BRIEF SUMMARY

Methods for performing a candidate resource selection procedure are disclosed. Apparatuses and systems also perform the functions of the methods. One embodiment of a method includes receiving, at a first user equipment (“UE”), configuration information including a candidate resource selection procedure to overbook at least one time-frequency resource reserved by at least one second UE and a plurality of LBT starting positions for performing LBT. The configuration information includes an overbooking enabled flag, an overbooking factor, a relative priority, a threshold, or some combination thereof. In some embodiments, the method includes performing candidate resource selection. The candidate resource selection selects the at least one reserved time-frequency resource that fulfils the overbooking factor, the relative priority, the threshold, or some combination thereof. In certain embodiments, the method includes reporting the at least one reserved time-frequency resource to a higher layer. In various embodiments, the method includes determining an LBT starting position from the plurality of LBT starting positions. In some embodiments, the method includes performing LBT on the at least one reserved time-frequency resource based on the LBT starting position.

One apparatus for performing a candidate resource selection procedure includes a receiver to receive configuration information including a candidate resource selection procedure to overbook at least one time-frequency resource reserved by at least one second UE and a plurality of LBT starting positions for performing LBT. The configuration information includes an overbooking enabled flag, an overbooking factor, a relative priority, a threshold, or some combination thereof. In some embodiments, the apparatus includes a processor to: perform candidate resource selection, wherein the candidate resource selection selects the at least one reserved time-frequency resource that fulfils the overbooking factor, the relative priority, the threshold, or some combination thereof; report the at least one reserved time-frequency resource to a higher layer; determine an LBT starting position from the plurality of LBT starting positions; and perform LBT on the at least one reserved time-frequency resource based on the LBT starting position.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing a candidate resource selection procedure;

FIG. 2 is a schematic block diagram illustrating one embodiment of an apparatus that may be used for performing a candidate resource selection procedure;

FIG. 3 is a schematic block diagram illustrating one embodiment of an apparatus that may be used for performing a candidate resource selection procedure;

FIG. 4 is a schematic block diagram illustrating one embodiment of a system for performing a candidate resource selection procedure;

FIG. 5 is a schematic block diagram illustrating another embodiment of a system for performing a candidate resource selection procedure; and

FIG. 6 is a flow chart diagram illustrating one embodiment of a method for performing a candidate resource selection procedure.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

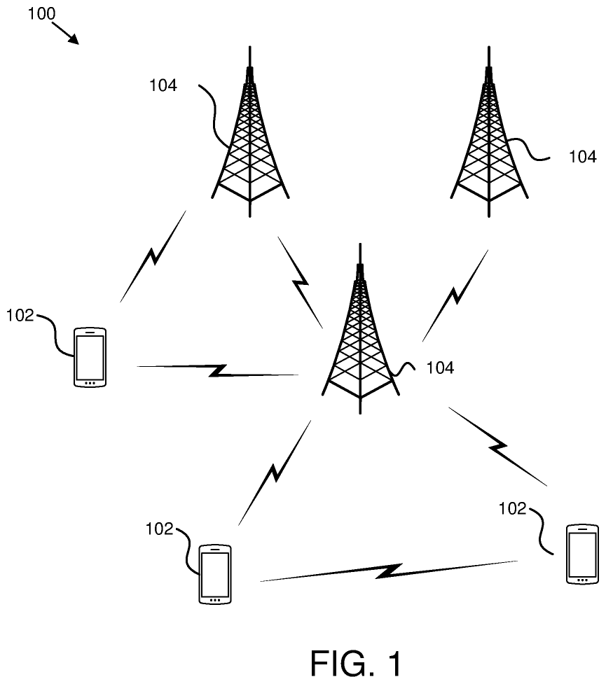

FIG. 1 depicts an embodiment of a wireless communication system 100 for performing a candidate resource selection procedure. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive configuration information including a candidate resource selection procedure to overbook at least one time-frequency resource reserved by at least one second UE and a plurality of LBT starting positions for performing LBT. The configuration information includes an overbooking enabled flag, an overbooking factor, a relative priority, a threshold, or some combination thereof. In some embodiments, the remote unit 102 may perform candidate resource selection. The candidate resource selection selects the at least one reserved time-frequency resource that fulfils the overbooking factor, the relative priority, the threshold, or some combination thereof. In certain embodiments, the remote unit 102 may report the at least one reserved time-frequency resource to a higher layer. In various embodiments, the remote unit 102 may determine an LBT starting position from the plurality of LBT starting positions. In some embodiments, the remote unit 102 may perform LBT on the at least one reserved time-frequency resource based on the LBT starting position. Accordingly, the remote unit 102 may be used for performing a candidate resource selection procedure.

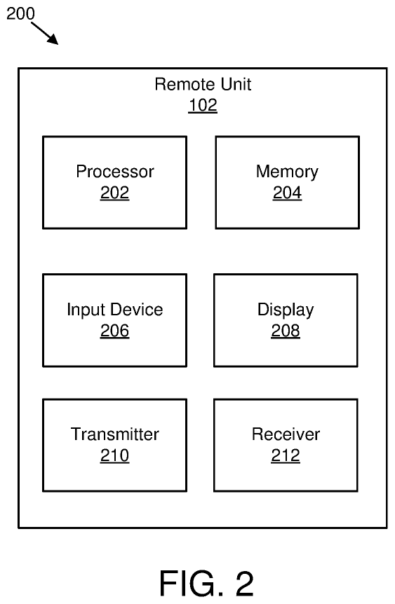

FIG. 2 depicts one embodiment of an apparatus 200 that may be used for performing a candidate resource selection procedure. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to receive configuration information including a candidate resource selection procedure to overbook at least one time-frequency resource reserved by at least one second UE and a plurality of LBT starting positions for performing LBT. The configuration information includes an overbooking enabled flag, an overbooking factor, a relative priority, a threshold, or some combination thereof. In some embodiments, the processor 202 to: perform candidate resource selection, wherein the candidate resource selection selects the at least one reserved time-frequency resource that fulfils the overbooking factor, the relative priority, the threshold, or some combination thereof; report the at least one reserved time-frequency resource to a higher layer; determine an LBT starting position from the plurality of LBT starting positions; and perform LBT on the at least one reserved time-frequency resource based on the LBT starting position.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

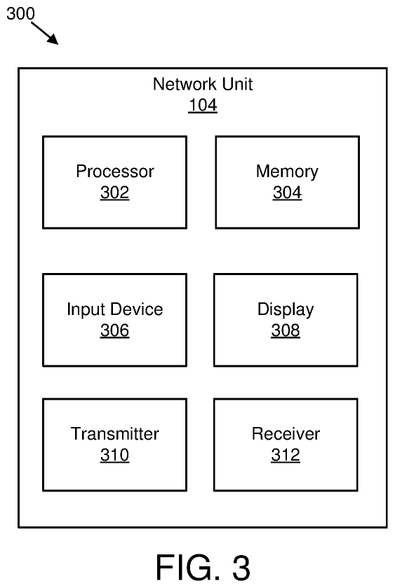

FIG. 3 depicts one embodiment of an apparatus 300 that may be used for performing a candidate resource selection procedure. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, sidelink (“SL”) unlicensed operation may be used and a channel access mechanism for SL in an unlicensed band may be used.

In some embodiments, SL devices perform channel access mechanism using an listen-before-talk (“LBT”) procedure in the unlicensed spectrum. As part of the LBT procedure, a transmitter may determine whether a channel is free or busy by sensing the channel, and the transmitted may perform a transmission only if the channel is free.

In some embodiments, gNB initiated COT sharing and/or UE initiated COT sharing may be used. In various embodiments, a group common downlink control information (“DCI”) format 2_0 may indicate one or more COT sharing indicators initiated by the gNB to each of multiple cells, and a UE initiated COT sharing indicator may be shared to a gNB using a field in configured grant (“CG”) uplink control information (“UCI”) (“CG-UCI”).

In certain embodiments, COT sharing indicator may be used in SL for an unlicensed spectrum to get feedback from receiver (“RX”) UEs, physical sidelink shared channel (“PSSCH”) transmission from RX UEs, and so forth in a remaining channel occupancy duration. In some embodiments, UE-to-UE COT sharing procedures may consider a transmitter (“TX”) UE connection with multiple RX UEs and/or destination identifiers (“IDs”).

In some embodiments, when a sidelink device successfully performs a clear channel assessment procedure on an indicated resource using a mode 1 grant and a selected and/or a reserved resource using a mode 2 procedure, the sidelink device starts a burst transmission until the end of the channel occupancy duration specified according to the channel access priority class (“CAPC”) value and may block LBT from other UEs, which may lead to LBT blocking issues.

In various embodiments, when LBT fails on one or more reserved resources, since these resources were orthogonally provided by mode 1 grant or selected by mode 2 procedure, it may go wasted. Hence the mode 1 and mode 2 resource allocation may be allowed to overbook the SL resources from the system perspective which means allowing more than one UE to select or indicate the same time frequency resource and then a UE which completes the LBT successfully may transmit in those SL resources, other UEs transmission on the same time and/or frequency may be blocked due to successful LBT from other UEs.

In certain embodiments as described herein, changes in a resource allocation are used to allow overbooking of SL resources by more than one UE. In some embodiments, such as mode 2 resource allocation, a physical layer (“PHY”) excludes slots already reserved by other UEs, which requires some changes to overbooking of resources.

In some embodiments there may be a mode 2 resource allocation as follows:

### A) UE Procedure for Determining the Subset of Resources to be Reported to Higher Layers in PSSCH Resource Selection in Sidelink Resource Allocation Mode 2:

In resource allocation mode 2, the higher layer can request the UE to determine a subset of resources from which the higher layer will select resources for PSSCH and/or physical sidelink control channel (“PSCCH”) transmission. To trigger this procedure, in slot n, the higher layer provides the following parameters for this PSSCH and/or PSCCH transmission:
1) the resource pool from which the resources are to be reported;
2) L1 priority, prio_{TX};
3) the remaining packet delay budget;
4) the number of sub-channels to be used for the PSSCH/PSCCH transmission in a slot, L_{subCH};
5) optionally, the resource reservation interval, P_{rsvp_TX}, in units of msec;
6) if the higher layer requests the UE to determine a subset of resources from which the higher layer will select resources for PSSCH/PSCCH transmission as part of re-evaluation or pre-emption procedure, the higher layer provides a set of resources (r₀, r₁, r₂, . . . ) which may be subject to re-evaluation and a set of resources (r′₀, r′₁, r′₂, . . . ) which may be subject to pre-emption;
7) it is up to UE implementation to determine the subset of resources as requested by higher layers before or after the slot r″ᵢ−T₃, where r″ᵢ is the slot with the smallest slot index among (r₀, r₁, r₂, . . . ) and (r′₀, r′₁, r′₂, . . . ), and T₃ is equal to T_{proc,1}^{SL}, where T_{proc,1}^{SL} is defined where μ_{SL} is the subcarrier spacing (“SCS’) configuration of the SL bandwidth part (“BWP”); and
8) optionally, the indication of resource selection mechanism(s), as allowedResourceSelectionConfig, which may comprise of full sensing only, partial sensing only, random resource selection only, or any combination(s) thereof.

In some embodiments, the following higher layer parameters affect this procedure;
1) sl-Selection WindowList: internal parameter T₂ₘᵢₙ is set to the corresponding value from higher layer parameter sl-SelectionWindow List for the given value of prio_{TX};
2) sl-Thres-reference signal received power (“RSRP”)-List: this higher layer parameter provides an RSRP threshold for each combination (pᵢ, pⱼ), where pᵢ is the value of the priority field in a received sidelink control information (“SCI”) format 1-A and pⱼ is the priority of the transmission of the UE selecting resources; for a given invocation of this procedure, pⱼ=prio_{TX};
3) sl-RS-ForSensing selects if the UE uses the PSSCH-RSRP or PSCCH-RSRP measurement;
4) sl-ResourceReservePeriodList;
5) sl-SensingWindow: internal parameter T₀ is defined as the number of slots corresponding to sl-Sensing Window msec;
6) sl-TxPercentageList: internal parameter X for a given prio_{TX} is defined as sl-TxPercentageList (prio_{TX}) converted from percentage to ratio;
7) sl-PreemptionEnable: if sl-PreemptionEnable is provided, and if it is not equal to ‘enabled’, internal parameter prioₚᵣₑ is set to the higher layer provided parameter sl-PreemptionEnable;
8) optionally, minimum number of Y slots as Yₘᵢₙ (minNumCandidateSlotsPeriodic), which indicates the minimum number of Y slots that are included in the resources corresponding to periodic-based partial sensing;
9) optionally, minimum number of slots as Y′ₘᵢₙ (minNumCandidateSlotsAperiodic), which indicates the minimum number of Y′ slots that are included in the resources corresponding to contiguous partial sensing;
10) optionally, sensing occasion as sl-PBPS-OccasionReservePeriodList, which indicates the subset of periodicity values from sl-ResourceReservePeriodList used to determine periodic sensing occasions in periodic-based partial sensing. If not configured, all periodicity values from sl-ResourceReservePeriodList are used to determine periodic sensing occasions in periodic-based partial sensing;
11) optionally, additional sensing occasions as sl-Additional-PBPS-Occasion, which indicates that UE additionally monitors periodic sensing occasions that correspond to a set of values. The possible values of the set at least includes the most recent sensing occasion before the first slot of the candidate slots for a given reservation periodicity and the last periodic sensing occasion prior to the most recent one for the given reservation periodicity. If not configured, the UE monitors the most recent sensing occasion before the first slot of the candidate slots for the given periodicity used to determine periodic sensing occasions in periodic-based partial sensing;
12) optionally, indication of the size in logical slots of contiguous partial sensing window for periodic transmissions as defined by the parameter sl-CPS-Window Periodic;
13) optionally, indication of the size in logical slots of contiguous partial sensing window for aperiodic transmissions as defined by the parameter sl-CPS-Window Aperiodic; and
14) optionally, indication of whether UE is required to perform SL reception of PSCCH and RSRP measurement for partial sensing on slots in SL discontinuous reception (“DRX”) inactive time as partialSensingInactiveTime.

The resource reservation interval, P_{rsvp_TX}, if provided, is converted from units of msec to units of logical slots, resulting in

$${P}_{rsvp\_TX}^{′} .$$

When the resource pool is (pre-)configured with allowedResourceSelectionConfig including full sensing, and full sensing is (pre-)configured in the UE by higher layers, the UE performs full sensing.

When periodic reservation for another transport block (“TB”) (sl-MultiReserveResource) is enabled for the resource pool, the resource pool is (pre-)configured with allowedResourceSelectionConfig including partial sensing, and partial sensing is configured by higher layer, the UE performs periodic-based partial sensing, unless other conditions state otherwise in the specification.

When a UE is triggered by higher layer to report resources for resource (re-)selection in a mode 2 Tx pool, the resource pool is (pre-)configured with allowedResourceSelectionConfig including partial sensing, and partial sensing is configured by higher layer, the UE may perform contiguous partial sensing.

It should be noted that

$$( {t}_{0}^{′ SL} , {t}_{1}^{′ SL} , {t}_{2}^{′ SL} , … )$$

denotes the set of slots which belongs to the sidelink resource pool.

In various embodiments, the following steps may be used:
1) a candidate single-slot resource for transmission R_{x,y} is defined as a set of L_{subCH} contiguous sub-channels with sub-channel x+j in slot

$${t}_{y}^{′ SL}$$

where j=0, . . . , L_{subCH}−1. The UE shall assume that any set of L_{subCH} contiguous sub-channels included in the corresponding resource pool within the time interval [n+T₁, n+T₂] correspond to one candidate single-slot resource for UE performing full sensing, in a set of Y candidate slots within the time interval [n+T₁, n+T₂] for UE performing periodic-based partial sensing correspond to one candidate single-slot resource, or in a set of Y′ candidate slots within the time interval [n+T₁, n+T₂] for UE performing contiguous partial sensing if Prsvp_TX=0, correspond to one candidate single-slot resource, where:
a) selection of T₁ is up to UE implementation under

$$0 \leq {T}_{1} \leq {T}_{p roc , 1}^{S L} ,$$

where

$${T}_{p roc , 1}^{S L}$$

is defined in slots where μ_{SL} is the SCS configuration of the SL BWP;
b) if T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots);
c) Y is selected by UE where Y≥Yₘᵢₙ;
d) Y′ is selected by UE where

$${Y}^{′} \geq {Y}_{min}^{′} .$$

When the UE performs contiguous partial sensing and if P_{rsvp_TX}=0, the UE selects a set of Y′ candidate slots with corresponding PBPS and/or CPS results (if available). If the number of candidate single-slot resources Y′ is smaller than Y′ₘᵢₙ, it is up to UE implementation to include other candidate slots; and
e) the total number of candidate single-slot resources is denoted by Mₜₒₜₐₗ.
2) the sensing window is defined by the range of slots

$$[ n - {T}_{0} , n - {T}_{p roc , 0}^{S L} ) ,$$

when the UE performs full sensing, where T₀ is defined above and

$${T}_{p roc , 0}^{S L}$$

is defined in slots where μ_{SL} is the SCS configuration of the SL BWP. The UE shall monitor slots which belongs to a sidelink resource pool within the sensing window except for those in which its own transmissions occur. The UE shall perform the behaviour in the following steps based on PSCCH decoded and RSRP measured in these slots.

When the UE performs periodic-based partial sensing, the UE shall monitor slots at

$${t}_{y - k \times {P}_{r e s e r ν e}^{′}}^{′ S L} ,$$

where

$${t}_{y}^{′ SL}$$

is a slot of the selected candidate slots and

$${P}_{r e s e r ν e}^{′}$$

is Pᵣₑₛₑᵣᵥₑ converted to units of logical slot. The UE shall perform the behavior in the following steps based on PSCCH decoded and RSRP measured in these slots.

The value of Pᵣₑₛₑᵣᵥₑ corresponds to sl-PBPS-OccasionReservePeriodList if configured, otherwise, the values correspond to all periodicity from sl-ResourceReservePeriodList.

The UE monitors k sensing occasions determined by sl-Additional-PBPS-Occasion, as previously described, and not earlier than n−T₀. For a given periodicity Pᵣₑₛₑᵣᵥₑ, the values of k correspond to the most recent sensing occasion earlier than

$${t}_{y 0}^{′ SL} - ( {T}_{p roc , 0}^{S L} + {T}_{p roc , 1}^{S L} )$$

if sl-Additional-PBPS-Occasion is not (pre-)configured, and additionally includes the value of k corresponding to the last periodic sensing occasion prior to the most recent one if sl-Additional-PBPS-Occasion is (pre-)configured.

$${t}_{y 0}^{′ SL}$$

is the first slow of the selected Ya candidate slots of PBPS.

When the UE performs periodic-based partial sensing and contiguous partial sensing with periodic reservation for another TB (sl-MultiReserveResource) enabled, the sensing window is defined by the range of slots [n+T_{A}, n+T_{B}]. n+TA is M consecutive logical slots earlier than slot

$${t}_{y 0}^{′ SL} , and n + TB is {T}_{p roc , 0}^{S L} + {T}_{p roc , 1}^{S L}$$

slots earlier than

$${t}_{y 0}^{′ SL} ,$$

where

$${t}_{y 0}^{′ SL}$$

is the first slot of the selected Y candidate slots of PBPS, and

$${T}_{p roc , 0}^{S L} , {T}_{p roc , 1}^{S L}$$

are in units of physical time/slots. If P_{rsvp_TX}≠0 the value of M is (pre-)configured with the sl-CPS-Window Periodic. If sl-CPS-Window Periodic is not (pre-)configured, M equals to 31. When the minimum M slots for CPS cannot be guaranteed and when P_{rsvp_TX}=0, it is up to UE implementation to either continue with step 3) or perform random selection.

When the UE performs contiguous partial sensing with periodic reservation for another TB (sl-MultiReserveResource) disabled and if P_{rsvp_TX}=0, the sensing window is defined by the range of slots [n+T_{A}, n+T_{B}]. T_{A} and T_{B} are both selected such that the UE has sensing results starting at least M consecutive logical slots before

$${t}_{y 0}^{′ SL}$$

and ending at

$${T}_{p roc , 0}^{S L} + {T}_{p roc , 1}^{S L}$$

slots earlier than

$${t}_{y 0}^{′ SL} .$$

The value of M is (pre-)configured with the sl-CPS-Window Aperiodic. If sl-CPS-WindowAperiodic is not (pre-)configured, M equals to 31. When the minimum M slots for CPS cannot be guaranteed and when P_{rsvp_TX}=0, it is up to UE implementation to either continue with step 3) or perform random selection.

Whether the UE is required to performs SL reception of PSCCH and RSRP measurement for partial sensing on slots in SL DRX inactive time is enabled/disabled by higher layer parameter partialSensingInactiveTime. When it is enabled, if UE performs periodic-based partial sensing on the slots in SL DRX inactive time for a given periodicity corresponding to Pᵣₑₛₑᵣᵥₑ, UE monitors only the default periodic sensing occasions (most recent sensing occasion) from the slots; if UE performs contiguous partial sensing on the slots in SL DRX inactive time, UE monitors a minimum of M slots from the slots.
3) the internal parameter Th(pᵢ, pⱼ) is set to the corresponding value of RSRP threshold indicated by the i-th field in sl-Thres-RSRP-List, where i=pᵢ+(pⱼ−1)*8;
4) the set S_{A} is initialized to the set of all the candidate single-slot resources;
5) the UE shall exclude any candidate single-slot resource R_{x,y} from the set S_{A} if it meets all the following conditions;
a) the UE has not monitored slot

$${t}_{m}^{′ SL}$$

in step 2; and
b) for any periodicity value allowed by the higher layer parameter sl-ResourceReservePeriodList and a hypothetical SCI format 1-A received in slot

$${t}_{m}^{′ SL}$$

with ‘Resource reservation period’ field set to that periodicity value and indicating all subchannels of the resource pool in this slot, condition c in step 6 would be met;
5a) if the number of candidate single-slot resources R_{x,y} remaining in the set S_{A} is smaller than X·Mₜₒₜₐₗ, the set S_{A} is initialized to the set of all the candidate single-slot resources as in step 4;
6) the UE shall exclude any candidate single-slot resource R_{x,y} from the set S_{A} if it meets all the following conditions:
a) the UE receives an SCI format 1-A in slot

$${t}_{m}^{′ SL} ,$$

and ‘Resource reservation period’ field, if present, and ‘Priority’ field in the received SCI format 1-A indicate the values P_{rsvp_RX} and prio_{RX}, respectively;
b) the RSRP measurement performed for the received SCI format 1-A is higher than Th(prio_{RX}, prio_{TX}); and
c) the SCI format received in slot

$${t}_{m}^{′ SL}$$

or the same SCI format which, if and only if the ‘Resource reservation period’ field is present in the received SCI format 1-A, is assumed to be received in slot(s)

$${t}_{m + q \times {P}_{rsvp\_RX}^{′}}^{′ SL}$$

determines the set of resource blocks and slots which overlaps with

$${R}_{x , y + j \times {P}_{rsvp\_TX}^{′}}$$

for q=1, 2, . . . , Q and j−0, 1, . . . , Cᵣₑₛₑₗ−1. Here,

$${P}_{rsvp\_RX}^{′}$$

is P_{rsvp_RX} converted to units of logical slots according to clause 8.1.7,

$$Q = ⌈ \frac{{T}_{s c a l}}{{P}_{rsvp\_RX}} ⌉$$

if P_{rsvp_RX}<T_{scal} and

$${n}^{′} - m \leq {P}_{rsvp\_RX}^{′} ,$$

where if the UE is configured with full sensing by its higher layer

$${t}_{{n}^{′}}^{′ SL}$$

$$n$$

if slot n belongs to the set

$$( {t}_{0}^{′ SL} , {t}_{1}^{′ SL} , … , {t}_{T {′}_{max} - 1}^{′ SL} ) ,$$

otherwise slot

$${t}_{{n}^{′}}^{′ SL}$$

is the first slot after slot n belonging to the set

$$( {t}_{0}^{′ SL} , {t}_{1}^{′ SL} , … , {t}_{{T}_{max}^{′} - 1}^{′ SL} ) ;$$

If UE is configured with partial sensing by its higher layer

$${t}_{{n}^{′}}^{′ SL} = {t}_{{y}_{i}}^{′ SL} - {T}_{proc , 1}^{SL}$$

if slot

$${t}_{{y}_{i}}^{′ SL} - {T}_{p roc , 1}^{SL}$$

belong to the set

$$( {t}_{0}^{′ SL} , {t}_{1}^{′ SL} , … , {t}_{{T}_{max}^{′} - 1}^{′ SL} ) ,$$

otherwise slot

$${t}_{{n}^{′}}^{′ SL}$$

is the first slot after slot

$${t}_{{y}_{i}}^{′ SL} - {T}_{p roc , 1}^{SL}$$

belonging to the set

$$( {t}_{0}^{′ SL} , {t}_{1}^{′ SL} , … , {t}_{{T}_{max}^{′} - 1}^{′ SL} ) .$$

Otherwise Q=1. If the UE is configured with full sensing by its higher layer, T_{scal} is set to selection window size T2 converted to units of msec. If UE is configured with partial sensing by its higher layer,

$${T}_{scal} = {t}_{{y}_{L}}^{′ SL} - ( {t}_{{y}_{L}}^{′ SL} - {T}_{p roc , 1}^{S L} )$$

shall be converted to milliseconds, where slot

$${t}_{{y}_{L}}^{′ SL}$$

is the last slot of the Y or Y′ candidate slots. The slot

$${t}_{{y}_{i}}^{′ SL}$$

is the first slot of the selected/remaining set of Y or Y′ candidate slots;
6a) this step is executed only if a certain procedure is triggered;
6b) this step is executed only if a certain procedure is triggered;
7) if the number of candidate single-slot resources remaining in the set S_{A} is smaller than X·Mₜₒₜₐₗ, then Th(pᵢ, pⱼ) is increased by 3 dB for each priority value Th(pᵢ, pⱼ) and the procedure continues with step 4.
7a) if sidelink DRX active time of RX UE is provided by the higher layer and there is no candidate single-slot resource remained within the sidelink DRX active time in the set S_{A}, the UE based on its implementation additionally selects and includes at least one candidate single-slot resources within the sidelink DRX active time in the set S_{A}.

The UE shall report set S_{A} to higher layers.

If a resource rᵢ from the set (r₀, r₁, r₂, . . . ) is not a member of S_{A}, then the UE shall report re-evaluation of the resource rᵢ to higher layers.

If a resource

$${r}_{i}^{′}$$

from the set

$$( {r}_{0}^{′} , {r}_{1}^{′} , {r}_{2}^{′} , … )$$

meets the conditions below then the UE shall report pre-emption of the resource

$${r}_{i}^{′}$$

to higher layers.

In certain embodiments:

$$1 ) {r}_{i}^{′}$$

is not a member of S_{A};

$$2 ) {r}_{i}^{′}$$

meets the conditions for exclusion in step 6, with Th(prio_{RX}, prio_{TX}) set to the final threshold after executing steps 1)-7), i.e. including all necessary increments for reaching X·Mₜₒₜₐₗ; and 3) the associated priority prio_{RX}, satisfies one of the following conditions: a) sl-Preemption Enable is provided and is equal to ‘enabled’ and prio_{TX}>prio_{RX}; or b) sl-PreemptionEnable is provided and is not equal to ‘enabled’, and prio_{RX}<prioₚᵣₑ and prio_{TX}>prio_{RX}.

TABLE 1
${T}_{proc , 0}^{SL} depending on sub - carrier spacing$

| μ_{SL} | ${T}_{proc , 0}^{SL} [ slots ]$ |
|---|---|
| 0 | 1 |
| 1 | 1 |
| 2 | 2 |
| 3 | 4 |

TABLE 2
${T}_{proc , 1}^{SL} depending on sub - carrier spacing$

| μ_{SL} | ${T}_{proc , 1}^{SL} [ slots ]$ |
|---|---|
| 0 | 3 |
| 1 | 5 |
| 2 | 9 |
| 3 | 17 |

When the UE performs periodic-based partial sensing and contiguous partial sensing, and when the UE is triggered to perform re-evaluation and pre-emption checking, and if Prsvp_TX≠0:
1) during the qth reservation period (q=0, 1, 2, . . . , Cresel−1), candidate resource set (S_{A}) is initialized to the remaining Y candidate slots starting from slot

$${t}_{y i}^{′ SL}$$

and ending at the last slot of the Y candidate slots, where the slot indices of the remaining Y candidate slots are equal to

$${t}_{y + q \times {P}_{rsvp \_ TX}^{′}}^{′ SL} ,$$

where

$${t}_{y}^{′ SL}$$

is a slot index of Y candidate slots used in the initial resource (re)selection;

$$2 ) {t}_{yi}^{′ SL}$$

is the first candidate slot after slot n+T3;
3) the UE performs PBPS for the remaining Y candidate slots according to

$${t}_{y ′ - k \times {P}_{reserve}^{′}}^{′ SL} ,$$

where

$${t}_{{y}^{′}}^{′ SL}$$

is a slot belonging to the remaining Y candidate slots, and k and Preserve are the same as resource (re)selection, where the values of k correspond to the most recent sensing occasion earlier than

$${t}_{y i}^{′ SL} - ( {T}_{proc , 0}^{SL} + {T}_{proc , 1}^{SL} )$$

if sl-Additional-PBPS-Occasion is not (pre-)configured, and additionally includes the value of k corresponding to the last periodic sensing occasion prior to the most recent one if sl-Additional-PBPS-Occasion is (pre-)configured;
4) the UE performs CPS starting from M logical slots earlier than

$${t}_{yi}^{′ SL} to {T}_{proc , 0}^{SL} + {T}_{proc , 1}^{SL}$$

slots earlier than

$${t}_{yi}^{′ SL} ;$$

and
5) by default, M is 31 unless (pre-)configured with another value. by sl-CPS-WindowPeriodic.

When the UE is triggered to perform re-evaluation and pre-emption checking, and if Prsvp_TX=0:
1) candidate resource set S_{A} is initialized to the remaining Y′ candidate slots starting from slot

$${t}_{yi}^{′ SL}$$

and ending at the last slot of the Y′ candidate slots, where

$${t}_{yi}^{′ SL}$$

is the first candidate slot after slot n+T3;
2) it is up to UE implementation that UE may perform PBPS for periodic sensing occasions after the resource (re)selection when higher layer parameter sl-MultiReserveResource is enabled;
3) UE performs CPS starting from at least M consecutive logical slots earlier than

$${t}_{yi}^{′ sL} to {T}_{proc , 0}^{SL} + {T}_{proc , 1}^{SL}$$

slots earlier than

$${t}_{yi}^{′ SL} ;$$

and
4) for minimum size M of the CPS monitoring window [n+TA, n+TB], by default, M is 31 unless (pre-)configured with another value, by sl-CPS-WindowAperiodic.

When the minimum M slots for CPS cannot be guaranteed, UE senses in all available slots starting from the resource (re)selection trigger slot of the same TB to

$${T}_{proc , 0}^{SL} + {T}_{proc , 1}^{SL}$$

slots earlier than

$${t}_{yi}^{′ SL} .$$

The UE re-evaluation and pre-emption checking is based on all available sensing results after n−T0.

### B) UE Procedure for Determining a Set of Preferred or Non-Preferred Resources for Another UE's Transmission:

When this procedure is triggered, the following parameters are provided by the higher layer:
1) the resource pool from which the preferred or non-preferred resources are to be determined;
2) the resource selection window [n+T₁, n+T₂] within which the preferred or non-preferred resources are to be determined;
3) the resource set type (either preferred or non-preferred resource set); and
4) if the resource set type indicates preferred set, then the higher layer additionally provides the following parameters:
a) L1 priority, prio_{TX};
b) the number of sub-channels to be used for the PSSCH/PSCCH transmission in a slot, L_{subCH}; and
c) the resource reservation period, P_{rsvp_TX}, if present.

The value of Cᵣₑₛₑₗ is determined by the UE.

When this procedure is triggered by another UE's explicit request, the fields in the request are interpreted as follows:
1) the field ‘Resource selection window location’ is the concatenation of the starting time location and the ending time location of the resource selection window. The starting and ending time locations of the resource selection window are each encoded in the same way as the reference slot; and
2) the field ‘Resource reservation period’ is encoded in the same way as the field of the same name in SCI format 1-A.

When determining a preferred resource set, the UE applies a certain procedure with the above parameters and the following modifications:

Step 6a) the UE excludes candidate single-slot resource(s) belonging to slot(s) where the UE does not expect to perform SL reception of a TB due to half-duplex operation, if all the following conditions are met:
a) the UE is a destination UE of the TB for whose transmission the preferred resource set is being determined; and
b) the higher layer parameter condition1A2Scheme1Disabled is not set to ‘Disabled’.

When determining a non-preferred resource set, the UE considers any resource(s) within the resource selection window, if indicated by a received explicit request, and satisfying at least one of the following conditions as non-preferred resource(s):
1) resource(s) indicated by a received [SCI format 1-A], satisfying at least one of the following criteria:
a) the RSRP measurement performed for the received [SCI format 1-A], is higher than Th(prio_{RX}) where prio_{RX} is the value of the priority field in the received [SCI format 1-A]. The internal parameter Th(pᵢ) is set to the corresponding value of RSRP threshold indicated by the k-th field in thresholdRSRPCondition1B1Option1Scheme1, where k=pᵢ; and
b) the UE is a destination UE of a TB associated with the received [SCI format 1-A] and the RSRP measurement performed for the received [SCI format 1-A] is lower than Th′(prio_{RX}) where prio_{RX} is the value of the priority field in the received [SCI format 1-A]. The internal parameter Th′(pᵢ) is set to the corresponding value of RSRP threshold indicated by the k-th field in thresholdRSRPCondition1B1Option2Scheme1, where k=pᵢ; and
2) resources(s) in slot(s) in which the UE does not expect to perform SL reception due to half duplex operation, if the UE is a destination UE of a TB for whose transmission the non-preferred resource set is being determined.

### C) UE Procedure for Determining a Resource Conflict:

A UE configured with the higher layer parameter interUECoordinationScheme2 enabling transmission of a resource conflict indication considers that a resource conflict occurs on a first reserved resource r₁ indicated by a first received SCI format if at least one of the following conditions is satisfied:
1) the first reserved resource r₁ overlaps with a second reserved resource r₂ indicated by a second received SCI format, and
a) if [the higher layer parameter for enabling Options 1/4 in Condition 2-A-1] indicates [Option 1 enabled],
a1) if the UE is a destination UE of a TB to be transmitted in r₁, the RSRP measurement performed for the second received SCI format RSRP₂ is higher than Th(prio₂, prio₁) where prio₁ and prio₂ are the priorities indicated in the first and second received SCI format, respectively; and
a2) if the UE is a destination UE of a TB to be transmitted in r₂, the RSRP measurement performed for the first received SCI format RSRP₁ is higher than Th(prio₁, prio₂) where prio₁ and prio₂ are the priorities indicated in the first and second received SCI format, respectively;
b) if [the higher layer parameter for enabling Options 1/4 in Condition 2-A-1] indicates [Option 4 enabled] and the UE supports [Option 4],
b1) if the UE is a destination UE of a TB to be transmitted in r₁, RSRP₂−RSRP₁ is higher than a (pre) configured RSRP threshold; and
b2) if the UE is a destination UE of a TB to be transmitted in r₂, RSRP₁−RSRP₂ is higher than a (pre) configured RSRP threshold;

c) where the RSRP₁, RSRP₂ measurements are performed according to clause 8.4.2.1 and the parameter Th(pᵢ, pⱼ) is determined;
2) the first reserved resource r₁ occurs in a slot in which the UE does not expect to perform SL reception due to half-duplex operation and the UE is a destination UE of a TB to be transmitted in resource r₁.

### D) UE Procedure for Using a Received Non-Preferred Resource Set:

A UE configured with the higher layer parameter interUECoordinationScheme1 uses a received non-preferred resource set as follows when performing resource (re-)selection:
the UE excludes in Step 6b) resource(s) overlapping with the non-preferred resource set.

It should be noted that, if it is not possible to meet the requirement that the number of candidate single-slot resources remaining in the set S_{A} be at least X·Mₜₒₜₐₗ after excluding resource(s) overlapping with the received non-preferred resource set, it is up to UE implementation whether or not to take into account the received non-preferred resource set to meet such requirement.

As used herein, the term eNB and/or gNB may be used for a base station (“BS”) but it may be replaceable by any other radio access node (e.g., access point (“AP”), NR, and so forth). Furthermore, certain embodiments described herein are discussed mainly in the context of 5G NR; however, the embodiments herein may be applicable to other mobile communication systems supporting serving cells and/or carriers being configured for sidelink communication over a vehicle to vehicle (“PC5”) interface.

In various embodiments, a resource (re)selection trigger may include an overbooking enabled flag allowing PHY candidate resource selection procedure not to exclude and select one or more resources reserved by other UEs. The resource pool may be (pre) configured with an overbooking factor which may imply the number of UEs allowed to reserve the same time and/or frequency resource. Moreover, the overbooking enabled flag indicated by medium access control (“MAC”) and the number of allowed overbooking or overbooking factor could be determined according to the priority of packet to be transmitted, otherwise according to the LBT failure statistics and/or channel busy radio (“CBR”) values.

In certain embodiments, candidate resource exclusion may not exclude already reserved resources. Moreover, a separate set of overbooked resource may be reported so that a MAC could decide to choose. In some embodiments, the MAC selects the already reserved resources according to a priority, a packet delay budget (“PDB”), LBT failures statistics, and so forth.

In various embodiments, a resource re-evaluation procedure may be used to monitor a selected resource for transmission and pre-emption may not be needed.

In certain embodiments, a UE may be configured with multiple LBT positions to access a channel on or before overbooked resources.

As used herein, the following definitions may be used for sidelink channel access mechanisms: 1) TX UE: a UE that transmits COT sharing information (e.g., a COT sharing indicator) via a sidelink connection; 2) RX UE: a UE that receives COT sharing information (e.g., a COT sharing indicator) via a sidelink connection; 3) COT initiator: a sidelink device that initiated a channel occupancy (e.g., TX UE); 4) COT donor: a sidelink device that transmits COT sharing information (e.g., a COT sharing indicator, a TX UE) —the COT donor may be identical to the COT initiator; and 5) COT recipient: a sidelink device that receives COT sharing information (e.g., a COT sharing indicator, a RX UE).

In a first embodiment, there may be mode 2 resource allocation to allow overbooking of SL resources by more than one UE. According to the first embodiment, in resource allocation mode 2, a higher layer may request the UE to determine a subset of resources from which the higher layer will select resources for PSSCH/PSCCH transmission while considering reporting one or more resources that are already reserved by other UEs. To trigger this procedure, in slot n, the higher layer could provide additional parameter in the resource (re)selection trigger such as an overbooking_enabled flag to be used in candidate resource exclusion and candidate resource selection. Another additional parameter in the resource (re)selection trigger may indicate an overbooking factor which implies how many UEs are allowed to reserve the same time and/or frequency resource for performing LBT.

In certain embodiments, a candidate resource exclusion step is relaxed with an indication from a higher layer to allow overbooking of resources. In such embodiments, the UE may not exclude the resources that are reserved by other UEs or whose reservation periodicity for reserving the resource is indicated by a SCI-1A.

In some embodiments, the UE further checks, in the exclusion step:
1) how many UEs have reserved the same time-frequency resource, if the number of reservations is equal or higher than the overbooking factor then that reserved resource is excluded;
2) if the resource is identified as reserved, then comparing the pᵢ is the value of the priority field in a received SCI format 1-A reserving the resources and pⱼ priority of the transmitting UE selecting resources (e.g., the idea is to allow UEs with different priority to overbook the resource or above certain configured priority threshold while UEs having a same priority or below a certain configured threshold may not be allowed to overbook the same resource);
3) if an RSRP value provided according to the priority of the packet is higher than the threshold and then the resource are identified as reserved from the reception of SCI-1A:
a) comparing the RSRP values associated to the received SCI1-A from one or more UEs reserving the resources and the transmitting UE selecting the resources—the idea is to allow UEs with different RSRP values or have values above a certain threshold (e.g., could be relative RSRP threshold) to overbook the resources which may allow at least one UE to successfully complete sensing—UEs measuring the same RSRP values or within the threshold may be excluded as they may exhibit similar (e.g., within a threshold) energy sensing from LBT; and
b) the RSRP threshold values may be selected according to an energy detection threshold from the channel access (e.g., LBT);
4) the UE may first create the set S_{A} containing overbooked resource and if there are not enough resources (e.g., number of candidate single-slot resources remaining in the set S_{A} is smaller than X·Mₜₒₜₐₗ), then the procedure is repeated with the legacy candidate resource exclusion and selection algorithm where the orthogonal resources may be selected until the set S_{A} is complete;
5) the UE may first create the S_{A} with the legacy mode 2 procedure and, if the candidate single-slot resources remaining in the set S_{A} is smaller than X·Mₜₒₜₐₗ, then the procedure is repeated allowing overbooking of the resources that are already reserved by other UEs using conditions described herein;
6) the UE may report two sets S_{A} of resources to a higher layer—where one set S_{A} provides overbooked candidate resources (e.g., optionally sorted according to the RSRP values) and the second set S_{A} provides orthogonal candidate resources to the higher layer;
7) otherwise, the UE may report a single set S_{A} resource which includes the overbooked resource and the legacy resources;
8) the MAC layer of the UE may select the resources for performing LBT,
a) the UE may select candidate resources using a ‘time first’ manner from one of the two sets based on an overbooking factor, a priority, and so forth,
b) otherwise, the UE may randomly select from these candidate resources;
9) the resource re-evaluation procedure to monitor the selected resource for pre-emption may not be needed and the pre-emption may not be needed; and
10) the UE may be configured with multiple LBT sensing slot (i.e., LBT positions) to access the channel on or before overbooked resources—the multiple LBT positions allow multiple UEs to perform LBT on the overbooked resources at different time instants, wherein the LBT sensing slot granularity is 9 us and multiple of LBT sensing slot of each 9 us are configured before the overbooked resource. Also, the LBT sensing slot granularity is 9 us, which is not aligned with sidelink symbol and/or slot granularity. Thus, it's possible that LBT is successful in the middle of a symbol. In one implementation, for symbol boundary alignment and to allow an LBT multiple sensing slot, cyclic prefix extension (“CPE”) may be used at the first symbol of the overbooked resource,
a) the multiple LBT positions (i.e., LBT sensing slot granularity is 9 us) may be configured for each of the overbooked resources and multiple LBT starting positions are configured in the resource pool or signaled as part of the COT structure and/or COT sharing indicator,
b) Option-1: LBT positions (i.e., LBT sensing slot granularity is 9 us) are ordered according to the priority where the UE having a higher priority may have an earlier starting position to perform LBT,
c) Option-2: LBT positions (i.e., LBT sensing slot granularity is 9 us) are ordered according to the PDB values where the UE having less PDB may have an earlier starting position, and
d) Option 3: LBT positions (i.e., LBT sensing slot granularity is 9 us) are ordered according to when SCI was transmitted (e.g., the UE transmitting SCI first may have the early starting position).

In a second embodiment, there may be a combining of mode 2, overbooking, and LBT. According to the second embodiment, the UE may perform sensing and candidate resource selection while overbooking on the already reserved resources by other UEs and this overbooking may be performed only to transmit an initial transmission. If the LBT is success, then the mode 2 resource selection may continue to reserve contiguously within the remaining COT or MCOT orthogonally without performing any overbooking of resources.

While the UE may check for further reservation within the remaining COT and the corresponding UE behavior may include initiating the COT, terminating the COT, deferring the COT, or COT sharing.

If the LBT fails, which means the LBT of other UE/WiFi is successful, then the mode 2 resource selection algorithm may need to reselect another candidate resource or perform resource reselection to select candidate resources possibly after a remaining duration or maximum COT (“MCOT”) initiated by another UE.

In a third embodiment, there may be a combining of mode 2 and LBT. According to the third embodiment, a UE performs sensing and resource selection based on resource selection procedures to select resources for an initial transmission and possibly for some retransmissions of a TB.

In the third embodiment, the UE starts performing clear channel assessment (“CCA”) and/or LBT as soon as the packet arrives at the buffer and selects the first available resource (e.g., from the set of available resources) when the channel is found to be available by the LBT procedure where such resources should consider DRX of the receiver UE. The selected resource may be within the active time of the receiver UE.

In a fourth embodiment, there may be a combining mode 2 and LBT. According to the fourth embodiment, the UE performs Cat 4 LBT and, if it is successful, then performs transmission using random resource selection or (pre) configured grant resource and may indicate a time domain resource allocation (“TDRA”) and a frequency domain resource assignment (“FDRA”) in SCI within the COT. Another UE may select non-overlapping resource using a mode 2 resource selection procedure within the COT by monitoring the SCI from the COT initiator. The COT initiator may indicate whether an LBT type or NO-LBT needs to be performed by other UE to access the remaining channel occupancy. The COT initiator may indicate a gap together with a cyclic prefix (“CP”) —external (“EXT”) symbol to allow another UE to perform Cat 2 LBT for transmission in the remaining channel occupancy duration. After that gap, both the COT initiator and the COT recipient (e.g., another UE performing Cat 2 LBT) may continue to transmit in the remaining channel occupancy duration.

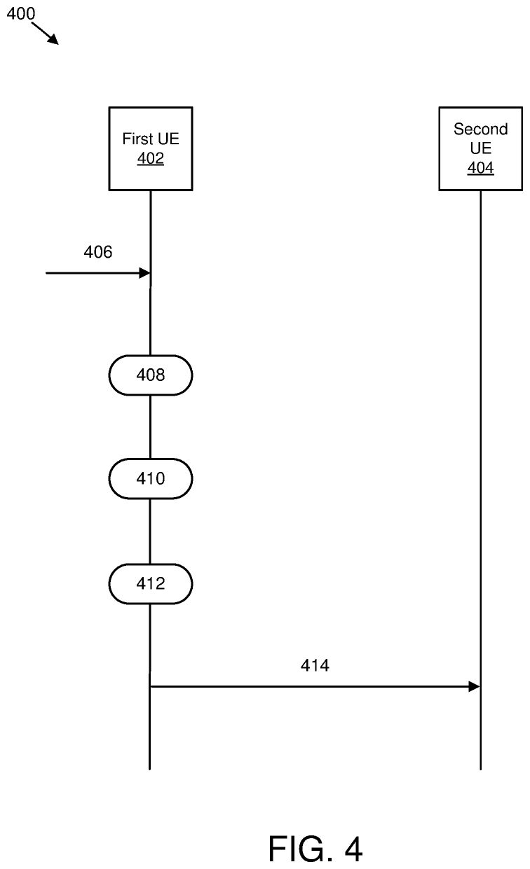

FIG. 4 is a schematic block diagram illustrating one embodiment of a system 400 for performing a candidate resource selection procedure. The system 400 includes a first UE 402 and a second UE 404 (e.g., at least one second UE). Each of the communications in the system 400 may include one or more messages.

In a first communication 406, the first UE 402 receives configuration information including a candidate resource selection procedure to overbook at least one time-frequency resource reserved by the at least one second UE 404 and multiple LBT starting positions for performing LBT. The configuration information includes an overbooking enabled flag, an overbooking factor, a relative priority, a threshold, or some combination thereof.

The first UE 402 performs 408 candidate resource selection. The candidate resource selection selects the at least one reserved time-frequency resource that fulfils the overbooking factor, the relative priority, the threshold, or some combination thereof.

Moreover, the first UE 402 reports 410 the at least one reserved time-frequency resource to a higher layer.

Further, the first UE 402 determines 412 an LBT starting position from the plurality of LBT starting positions.

In a second communication 414, the first UE 402 performs LBT on the at least one reserved time-frequency resource based on the LBT starting position.

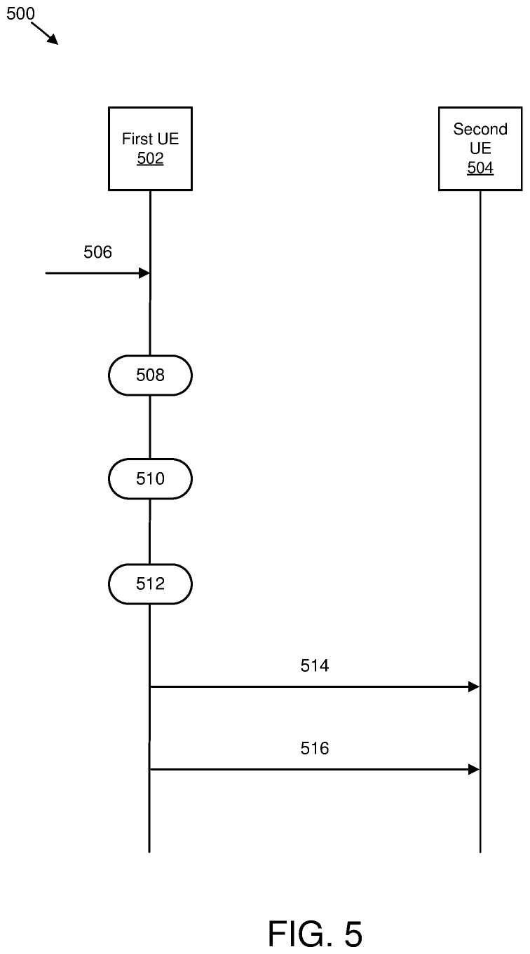

FIG. 5 is a schematic block diagram illustrating another embodiment of a system 500 for performing a candidate resource selection procedure. The system 500 includes a first UE 502 and a second UE 504 (e.g., at least one second UE). Each of the communications in the system 500 may include one or more messages.

In a first communication 506, the first UE 502 receives configuration information including a candidate resource selection procedure to overbook at least one time-frequency resource reserved by the at least one second UE 504 and multiple LBT starting positions for performing LBT. The configuration information includes an overbooking enabled flag, an overbooking factor, a relative priority, a threshold, or some combination thereof.

The first UE 502 performs 508 candidate resource selection. The candidate resource selection selects the at least one reserved time-frequency resource that fulfils the overbooking factor, the relative priority, the threshold, or some combination thereof.

Moreover, the first UE 502 reports 510 the at least one reserved time-frequency resource to a higher layer.

Further, the first UE 502 determines 512 an LBT starting position from the plurality of LBT starting positions.

In a second communication 514, the first UE 502 performs LBT on the at least one reserved time-frequency resource based on the LBT starting position.

Moreover, in a third communication 516, the first UE 502 configures the plurality of LBT starting positions to the at least one second UE to perform LBT on the at least one reserved time-frequency resource according to the relative priority, a PDB, or a combination thereof.

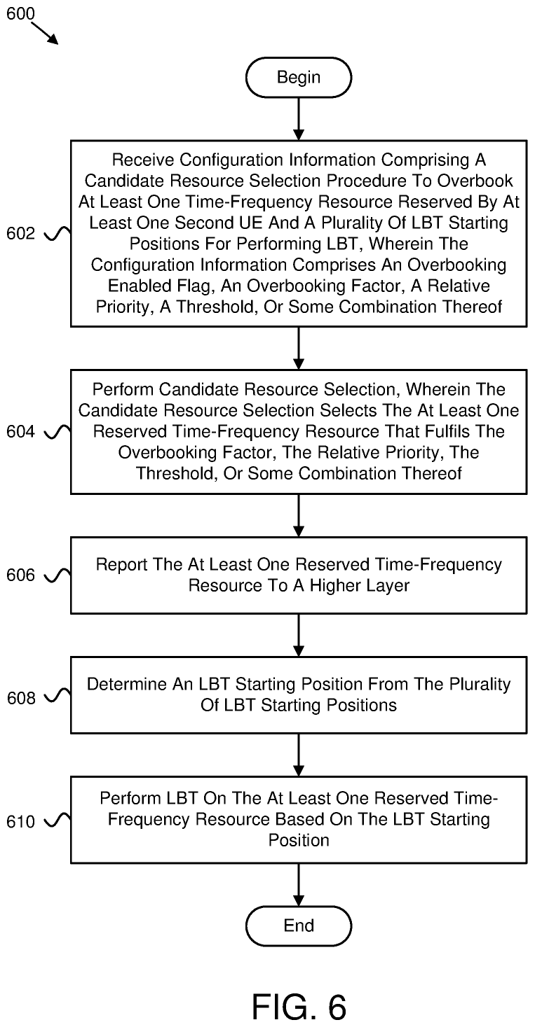

FIG. 6 is a flow chart diagram illustrating one embodiment of a method 600 for performing a candidate resource selection procedure. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602 configuration information including a candidate resource selection procedure to overbook at least one time-frequency resource reserved by at least one second UE and a plurality of LBT starting positions for performing LBT. The configuration information includes an overbooking enabled flag, an overbooking factor, a relative priority, a threshold, or some combination thereof. In some embodiments, the method 600 includes performing 604 candidate resource selection. The candidate resource selection selects the at least one reserved time-frequency resource that fulfils the overbooking factor, the relative priority, the threshold, or some combination thereof. In certain embodiments, the method 600 includes reporting 606 the at least one reserved time-frequency resource to a higher layer. In various embodiments, the method 600 includes determining 608 an LBT starting position from the plurality of LBT starting positions. In some embodiments, the method 600 includes performing 610 LBT on the at least one reserved time-frequency resource based on the LBT starting position.

In certain embodiments, the method 600 further comprises configuring the plurality of LBT starting positions to the at least one second UE to perform LBT on the at least one reserved time-frequency resource according to the relative priority, a PDB, or a combination thereof. In some embodiments, the method 600 further comprises determining to select the at least one reserved time-frequency resource using the relative priority, the threshold, or the combination thereof. In various embodiments, reporting the at least one reserved time-frequency resource to the higher layer comprises reporting only an overbooked resource, only an orthogonal resource, or a both of the overbooked resource and the orthogonal resource.

In one embodiment, the method 600 further comprises reporting a set of candidate resources to the higher layer, wherein the set of candidate resources comprises a set of candidate overbooked resources and a set of candidate orthogonal resources. In certain embodiments, the method 600 further comprises selecting the set of candidate overbooked resources, wherein the set of candidate overbooked resources is smaller than a configured required total number of resources. In some embodiments, the candidate resource selection selects the at least one reserved time-frequency resource from the set of candidate overbooked resources.

In various embodiments, the method 600 further comprises selecting the set of candidate orthogonal resources, wherein the set of candidate orthogonal resource is smaller than a configured required total number of resources. In one embodiment, the candidate resource selection selects the at least one reserved time-frequency resource from the set of candidate orthogonal resources. In certain embodiments, the threshold comprises a RSRP threshold.

In one embodiment, an apparatus comprises: a receiver to receive configuration information comprising a candidate resource selection procedure to overbook at least one time-frequency resource reserved by at least one second UE and a plurality of LBT starting positions for performing LBT, wherein the configuration information comprises an overbooking enabled flag, an overbooking factor, a relative priority, a threshold, or some combination thereof; and a processor to: perform candidate resource selection, wherein the candidate resource selection selects the at least one reserved time-frequency resource that fulfils the overbooking factor, the relative priority, the threshold, or some combination thereof; report the at least one reserved time-frequency resource to a higher layer; determine an LBT starting position from the plurality of LBT starting positions; and perform LBT on the at least one reserved time-frequency resource based on the LBT starting position.

In certain embodiments, the processor further to configure the plurality of LBT starting positions to the at least one second UE to perform LBT on the at least one reserved time-frequency resource according to the relative priority, a PDB, or a combination thereof.

In some embodiments, the processor further to determine to select the at least one reserved time-frequency resource using the relative priority, the threshold, or the combination thereof.

In various embodiments, reporting the at least one reserved time-frequency resource to the higher layer comprises reporting only an overbooked resource, only an orthogonal resource, or a both of the overbooked resource and the orthogonal resource.

In one embodiment, the processor further to report a set of candidate resources to the higher layer, and the set of candidate resources comprises a set of candidate overbooked resources and a set of candidate orthogonal resources.

In certain embodiments, the processor further to select the set of candidate overbooked resources, and the set of candidate overbooked resources is smaller than a configured required total number of resources.

In some embodiments, the candidate resource selection selects the at least one reserved time-frequency resource from the set of candidate overbooked resources.

In various embodiments, the processor further to select the set of candidate orthogonal resources, and the set of candidate orthogonal resource is smaller than a configured required total number of resources.

In one embodiment, the candidate resource selection selects the at least one reserved time-frequency resource from the set of candidate orthogonal resources.

In certain embodiments, the threshold comprises a RSRP threshold.

In one embodiment, a method of a first UE, the method comprises: receiving configuration information comprising a candidate resource selection procedure to overbook at least one time-frequency resource reserved by at least one second UE and a plurality of LBT starting positions for performing LBT, wherein the configuration information comprises an overbooking enabled flag, an overbooking factor, a relative priority, a threshold, or some combination thereof; performing candidate resource selection, wherein the candidate resource selection selects the at least one reserved time-frequency resource that fulfils the overbooking factor, the relative priority, the threshold, or some combination thereof; reporting the at least one reserved time-frequency resource to a higher layer; determining an LBT starting position from the plurality of LBT starting positions; and performing LBT on the at least one reserved time-frequency resource based on the LBT starting position.

In certain embodiments, the method further comprises configuring the plurality of LBT starting positions to the at least one second UE to perform LBT on the at least one reserved time-frequency resource according to the relative priority, a PDB, or a combination thereof.

In some embodiments, the method further comprises determining to select the at least one reserved time-frequency resource using the relative priority, the threshold, or the combination thereof.

In various embodiments, reporting the at least one reserved time-frequency resource to the higher layer comprises reporting only an overbooked resource, only an orthogonal resource, or a both of the overbooked resource and the orthogonal resource.

In one embodiment, the method further comprises reporting a set of candidate resources to the higher layer, wherein the set of candidate resources comprises a set of candidate overbooked resources and a set of candidate orthogonal resources.

In certain embodiments, the method further comprises selecting the set of candidate overbooked resources, wherein the set of candidate overbooked resources is smaller than a configured required total number of resources.

In some embodiments, the candidate resource selection selects the at least one reserved time-frequency resource from the set of candidate overbooked resources.

In various embodiments, the method further comprises selecting the set of candidate orthogonal resources, wherein the set of candidate orthogonal resource is smaller than a configured required total number of resources.

In one embodiment, the candidate resource selection selects the at least one reserved time-frequency resource from the set of candidate orthogonal resources.

In certain embodiments, the threshold comprises a RSRP threshold.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A first user equipment (UE), comprising:
at least one memory; and
at least one processor coupled with the at least one memory and configured to cause the first UE to:
receive configuration information comprising a candidate resource selection procedure to overbook at least one time-frequency resource reserved by at least one second UE and a plurality of listen-before-talk (LBT) starting positions for performing LBT, wherein the configuration information comprises an overbooking enabled flag, an overbooking factor, a relative priority, a threshold, or a combination thereof;
perform candidate resource selection, wherein the candidate resource selection selects the at least one reserved time-frequency resource that fulfils the overbooking factor, the relative priority, the threshold, or a combination thereof;
report the at least one reserved time-frequency resource to a higher layer;
determine an LBT starting position from the plurality of LBT starting positions; and
perform LBT on the at least one reserved time-frequency resource based on the LBT starting position.

2. The first UE of claim 1, wherein the at least one processor is configured to cause the first UE to configure the plurality of LBT starting positions to the at least one second UE to perform LBT on the at least one reserved time-frequency resource according to the relative priority, a packet delay budget (PDB), or a combination thereof.

3. The first UE of claim 1, wherein the at least one processor is configured to cause the first UE to determine to select the at least one reserved time-frequency resource using the relative priority, the threshold, or the combination thereof.

4. The first UE of claim 1, wherein reporting the at least one reserved time-frequency resource to the higher layer comprises reporting only an overbooked resource, only an orthogonal resource, or a both of the overbooked resource and the orthogonal resource.

5. The first UE of claim 1, wherein the at least one processor is configured to cause the first UE to report a set of candidate resources to the higher layer, and the set of candidate resources comprises a set of candidate overbooked resources and a set of candidate orthogonal resources.

6. The first UE of claim 5, wherein the at least one processor is configured to cause the first UE to select the set of candidate overbooked resources, and the set of candidate overbooked resources is smaller than a configured required total number of resources.

7. The first UE of claim 6, wherein the candidate resource selection selects the at least one reserved time-frequency resource from the set of candidate overbooked resources.

8. The first UE of claim 5, wherein the at least one processor is configured to cause the first UE to select the set of candidate orthogonal resources, and the set of candidate orthogonal resource is smaller than a configured required total number of resources.

9. The first UE of claim 8, wherein the candidate resource selection selects the at least one reserved time-frequency resource from the set of candidate orthogonal resources.

10. The first UE of claim 1, wherein the threshold comprises a reference signal received power (RSRP) threshold.

11. A method performed by a first user equipment (UE), the method comprising:
receiving configuration information comprising a candidate resource selection procedure to overbook at least one time-frequency resource reserved by at least one second UE and a plurality of listen-before-talk (LBT) starting positions for performing LBT, wherein the configuration information comprises an overbooking enabled flag, an overbooking factor, a relative priority, a threshold, or a combination thereof;
performing candidate resource selection, wherein the candidate resource selection selects the at least one reserved time-frequency resource that fulfils the overbooking factor, the relative priority, the threshold, or a combination thereof;
reporting the at least one reserved time-frequency resource to a higher layer;
determining an LBT starting position from the plurality of LBT starting positions; and
performing LBT on the at least one reserved time-frequency resource based on the LBT starting position.

12. The method of claim 11, further comprising configuring the plurality of LBT starting positions to the at least one second UE to perform LBT on the at least one reserved time-frequency resource according to the relative priority, a packet delay budget (PDB), or a combination thereof.

13. The method of claim 11, further comprising determining to select the at least one reserved time-frequency resource using the relative priority, the threshold, or the combination thereof.

14. The method of claim 11, wherein reporting the at least one reserved time-frequency resource to the higher layer comprises reporting only an overbooked resource, only an orthogonal resource, or a both of the overbooked resource and the orthogonal resource.

15. The method of claim 11, further comprising reporting a set of candidate resources to the higher layer, wherein the set of candidate resources comprises a set of candidate overbooked resources and a set of candidate orthogonal resources.

16. The method of claim 15, further comprising selecting the set of candidate overbooked resources, wherein the set of candidate overbooked resources is smaller than a configured required total number of resources.

17. The method of claim 16, wherein the candidate resource selection selects the at least one reserved time-frequency resource from the set of candidate overbooked resources.

18. The method of claim 15, further comprising selecting the set of candidate orthogonal resources, wherein the set of candidate orthogonal resource is smaller than a configured required total number of resources.

19. The method of claim 18, wherein the candidate resource selection selects the at least one reserved time-frequency resource from the set of candidate orthogonal resources.

20. A processor for wireless communication, comprising:
at least one controller coupled with at least one memory and configured to cause the processor to:
receive configuration information comprising a candidate resource selection procedure to overbook at least one time-frequency resource reserved by at least one second UE and a plurality of listen-before-talk (LBT) starting positions for performing LBT, wherein the configuration information comprises an overbooking enabled flag, an overbooking factor, a relative priority, a threshold, or a combination thereof;
perform candidate resource selection, wherein the candidate resource selection selects the at least one reserved time-frequency resource that fulfils the overbooking factor, the relative priority, the threshold, or a combination thereof;
report the at least one reserved time-frequency resource to a higher layer;
determine an LBT starting position from the plurality of LBT starting positions; and
perform LBT on the at least one reserved time-frequency resource based on the LBT starting position.
